(19) United States
(12) Patent Application Publication
(10) Pub. No.: US 2026/0233252 A1
(43) Pub. Date: Aug. 13, 2026

(54) EXCITER AND ELECTRONIC DEVICE

(71) Applicant: Goertek Inc., Shandong (CN)

(72) Inventors: Haiyang Ding, Shandong (CN); Yuhang Dong, Shandong (CN); Tomokuni Wauke, Shandong (CN)

(73) Assignee: Goertek Inc., Shandog (CN)

(21) Appl. No.: 19/158,973

(22) PCT Filed: Feb. 23, 2024
(86) PCT No.: PCT/CN2024/078312

§ 371 Date: Aug. 22, 2025

(30) Foreign Application Priority Data
Feb. 24, 2023 (CN) 202310182771.6

(51) Int. Cl. B06B 1/16

(52) U.S. Cl. CPC B06B 1/16

(57) ABSTRACT

The present disclosure relates to an exciter and an electronic device. The exciter includes a housing, a driving member, and a rotating part. The housing has an installation cavity and has a first side wall and a second side wall arranged at an angle to each other. The driving member is disposed within the installation cavity. The rotating part is connected to the output end of the driving member and is arranged eccentrically. The driving member drives the rotating part to rotate to strike the first side wall or the second side wall, thereby forming an impact point on the first side wall or the second side wall. The impact point is non-coincident with the center of mass of the exciter. The present disclosure aims to provide an exciter that can generate a force sensation in the rotational direction. The exciter not only simplifies the structure but also enables high-speed continuous operation and produces a strong and clear force sensation.

### CROSS-REFERENCE TO RELATED APPLICATIONS

The present disclosure is a National Stage of International Application No. PCT/CN2024/078312, filed on Feb. 23, 2024, which claims priority to Chinese Patent Application No. 202310182771.6 filed on Feb. 24, 2023, both of which are hereby incorporated by reference in their entireties.

### TECHNICAL FIELD

The present disclosure relates to the technical field of vibration devices, and in particular to an exciter and an electronic device applying said exciter.

### BACKGROUND

Conventional vibration devices generate an illusion of a force seemingly directed in a particular direction by continuously producing asymmetric vibrations, which are also known as anisotropic vibrations.

Currently, there are two methods for generating such a force sensation. One method involves applying an asymmetric signal to a linear resonator and exploiting human perceptual illusions. In principle, this method can only produce a continuous directional force sensation and is incapable of generating discrete vibration outputs. Moreover, the equivalent force perceived through this method is relatively small, and the asymmetric signal induces parasitic vibrations, making it difficult to achieve a clear directional perception. The other method generates a strong force sensation by rapidly braking the linear resonator. This approach produces highly asymmetric vibrations and features a low level of parasitic vibrations, resulting in a distinct and well-isolated force sensation. However, this method requires the vibrating portion and the braking portion to be formed as separate components, and either portion must be continuously moved to switch between energy storage and braking states, thereby preventing high-speed continuous operation and leading to a complex device structure.

Nevertheless, such devices are limited to generating vibrations along a linear direction and are unable to produce a rotational force sensation.

### SUMMARY

The present disclosure aims to provide an exciter and an electronic device, which are designed to generate a rotational directional force sensation. The exciter not only simplifies the structure but also enables high-speed continuous operation, producing a strong and clear force sensation.

To achieve the above objectives, the present disclosure proposes an exciter, which comprises:
a housing, the housing having an installation cavity, the housing having a first side wall and a second side wall arranged at an angle to each other;
a driving member, the driving member being disposed within the installation cavity; and
a rotating part, the rotating part being connected to an output end of the driving member and being arranged eccentrically;
wherein the driving member drives the rotating part to rotate, so as to strike the first side wall or the second side wall, and to form an impact point on the first side wall or the second side wall, the impact point being non-coincident with the center of mass of the exciter.

In one embodiment, the angle of rotation of the rotating part driven by the driving member is 90°;
it is defined that when the driving member drives the rotating part to rotate in a forward direction, the rotating part strikes the first side wall;
it is defined that when the driving member drives the rotating part to rotate in a reverse direction, the rotating part strikes the second side wall.

In one embodiment, the first side wall is arranged perpendicularly to the second side wall.

In one embodiment, the driving member is disposed adjacent to the junction between the first side wall and the second side wall;
and/or, the distance from the impact point on the first side wall to the junction between the first side wall and the second side wall is equal to the distance from the impact point on the second side wall to the junction between the first side wall and the second side wall.

In one embodiment, the exciter further comprises a cushioning part;
the cushioning part is disposed on the first side wall and/or the second side wall, and is located at the impact point; or, the cushioning part is disposed on the rotating part, and when the driving member drives the rotating part to rotate, the cushioning part abuts against the impact point.

In one embodiment, the driving member is a rotor motor, the rotor motor being provided with a rotation shaft, the rotating part being provided with a shaft hole, the shaft hole being eccentrically arranged on the rotating part, the rotation shaft being inserted into the shaft hole.

In one embodiment, the rotating part comprises at least one mass block;
the mass block is made of metal or non-metal.

In one embodiment, the rotating part comprises a first mass block, a second mass block and a third mass block, the first mass block being connected to the output end of the driving member and being arranged eccentrically;
the second and the third mass blocks are sequentially connected and arranged along the radial direction of the rotating part; or, the second and the third mass blocks are sequentially connected and arranged along the circumferential direction of the first mass block.

The present disclosure also proposes an electronic device, which comprises:
a device body having an installation space therein; and
the exciter as described above, the exciter being disposed within the installation space.

In one embodiment, the impact point of the exciter is non-coincident with the center of mass of the electronic device.

The exciter of the technical solution of the present disclosure forms an installation cavity within the housing, thereby utilizing the installation cavity to install, fix, and protect the driving member and the rotating part, and forms a first side wall and a second side wall arranged at an angle to each other on the housing, so that the rotating part is connected to the output end of the driving member and is arranged eccentrically. Thus, when the driving member drives the rotating part to rotate, the rotating part strikes the first side wall or the second side wall, forming an impact point on the first side wall or the second side wall, and the impact point is non-coincident with the center of mass of the exciter. Therefore, when the rotating part strikes the first side wall or the second side wall, a torque can be generated in the rotational direction, enabling the exciter to produce a rotational directional force sensation. Meanwhile, by providing the structure in which the driving member drives the eccentrically arranged rotating part to rotate, the structure of the exciter is effectively simplified, and the exciter is enabled to achieve high-speed continuous operation and produce a strong and clear force sensation.

### BRIEF DESCRIPTION OF THE DRAWINGS

To more clearly illustrate the technical solutions in the embodiments of the present disclosure or in the existing technology, the following is a brief introduction to the drawings that are required in the descriptions of the embodiments or existing technology. It is evident that the drawings described below are merely some embodiments of the present disclosure. For those of ordinary skill in the art, without making inventive efforts, other drawings can also be obtained based on the structures shown in these drawings.

FIG. 1 is a schematic structural diagram of an exciter in one embodiment of the present disclosure.

FIG. 2 is an exploded view of an exciter without the housing in one embodiment of the present disclosure.

FIG. 3 is a schematic structural diagram of an exciter in the first state in one embodiment of the present disclosure.

FIG. 4 is a schematic structural diagram of an exciter in the second state in one embodiment of the present disclosure.

FIG. 5 is a schematic structural diagram of an electronic device in the first state in one embodiment of the present disclosure.

FIG. 6 is a schematic structural diagram of an electronic device in the second state in one embodiment of the present disclosure.

FIG. 7 is a test diagram of an electronic device in one embodiment of the present disclosure.

### REFERENCE NUMERALS AND DESIGNATIONS

| Numeral | Description |
|---|---|
| 100 | Exciter |
| 1 | Housing |
| 11 | Installation cavity |
| 12 | First side wall |
| 13 | Second side wall |
| 14 | Impact point |
| 2 | Driving member |
| 21 | Rotation shaft |
| 3 | Rotating part |
| 31 | Shaft hole |
| 32 | Mass block |
| 4 | Cushioning part |
| 500 | Device body |
| 510 | Installation space |
| 520 | Center of mass of the electronic device |
| 600 | Electronic device |

The realization of the objective of the present disclosure, its functional features and advantages will be further explained with reference to the accompanying drawings in conjunction with the embodiments.

### DETAILED DESCRIPTION

In the following description, the technical solutions of the embodiments of the present disclosure will be explained in detail with reference to the accompanying drawings. It should be understood that the embodiments described herein are merely illustrative examples of the present disclosure and are not intended to be exhaustive or limit the disclosure to the specific forms disclosed. All modifications and alternative embodiments that may be devised by persons skilled in the art without departing from the scope of the present disclosure are also encompassed within the protection defined by the appended claims.

It is further noted that, in the embodiments of the present disclosure, directional terms such as “upper,” “lower,” “left,” “right,” “front,” and “back” are used solely for the purpose of describing the relative positional relationships and movement states of the components under a specific orientation (as illustrated in the accompanying drawings). These directional indications may change accordingly when the orientation of the device changes.

Additionally, throughout the present disclosure, the phrase “and/or” encompasses three possible combinations. For example, the phrase “A and/or B” includes: (1) A alone, (2) B alone, and (3) both A and B together.

Furthermore, the use of ordinal terms such as “first,” “second,” etc., in the present disclosure is for descriptive purposes only and should not be construed as indicating relative importance or implying a specific number of the features so described. Therefore, a feature referred to as “first” or “second” may include one or more instances of that feature, either explicitly or implicitly. In addition, the technical solutions of the various embodiments may be combined with each other where such combinations are technically feasible to a person skilled in the art. If a combination of technical features is contradictory or otherwise not realizable, it shall be deemed that such a combination does not exist and is not within the scope of the present disclosure.

Conventional vibration devices generate an illusion of a force seemingly directed in a particular direction by continuously producing asymmetric vibrations, which are also known as anisotropic vibrations.

Currently, there are two methods for generating such a force sensation. One method involves applying an asymmetric signal to a linear resonator and exploiting human perceptual illusions. In principle, this method can only produce a continuous directional force sensation and is incapable of generating discrete vibration outputs. Moreover, the equivalent force perceived through this method is relatively small, and the asymmetric signal induces parasitic vibrations, making it difficult to achieve a clear directional perception. The other method generates a strong force sensation by rapidly braking the linear resonator. This approach produces highly asymmetric vibrations and features a low level of parasitic vibrations, resulting in a distinct and well-isolated force sensation. However, this method requires the vibrating portion and the braking portion to be formed as separate components, and either portion must be continuously moved to switch between energy storage and braking states, thereby preventing high-speed continuous operation and leading to a complex device structure.

Nevertheless, such devices are limited to generating vibrations along a linear direction and are unable to produce a rotational force sensation.

Based on the above concepts and problems, the present disclosure proposes an exciter 100. It can be understood that the exciter 100 is applied to an electronic device. The electronic device may be, without limitation, a tactile display, a tactile interface, a force-feedback device, a vibratory feeder, a beauty product, a personal hygiene product, a personal entertainment product, a personal massager, a feller machine, or a seismic vibrator. For example, a wireless controller for gaming, a motion controller for sports gaming, a wireless steering wheel, or a remote controller for sports gaming in a game console, etc.; no limitation is imposed here.

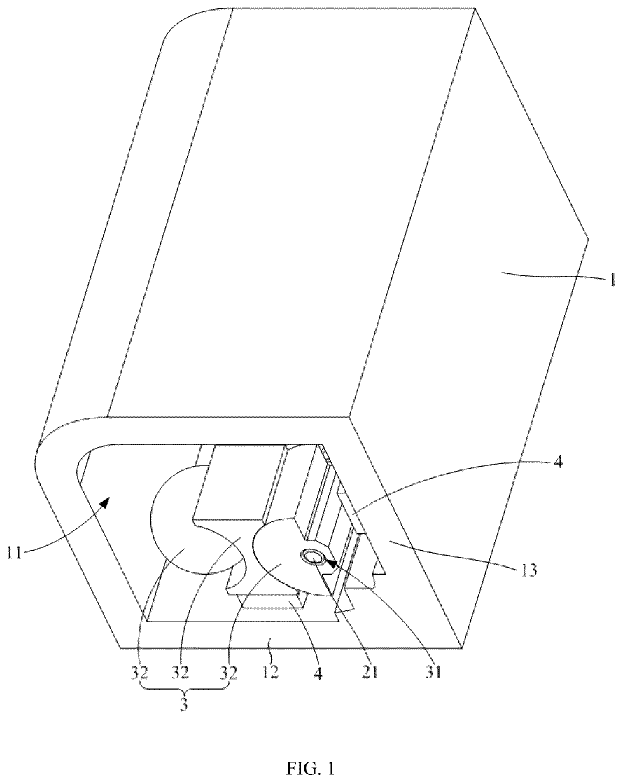

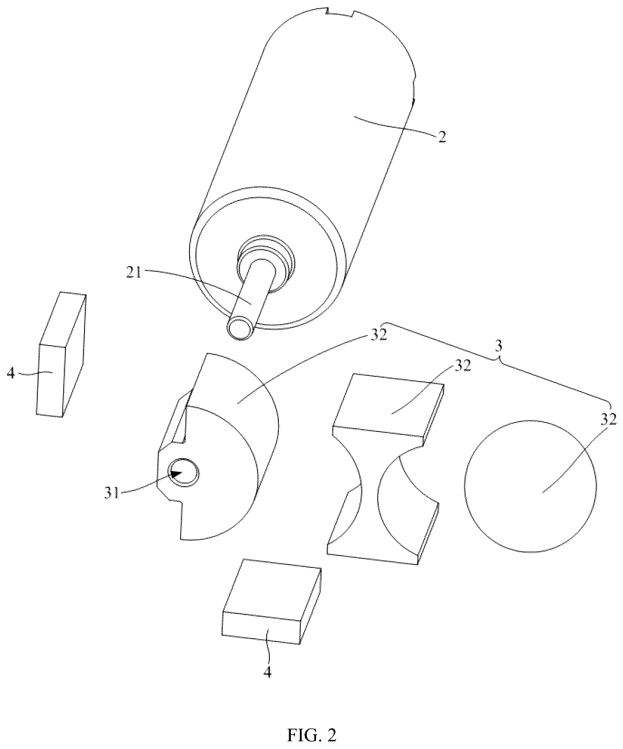

Please refer to FIGS. 1 to 6. In the embodiment of the present disclosure, the exciter 100 includes a housing 1, a driving member 2, and a rotating part 3. The housing 1 has an installation cavity 11 and has a first side wall 12 and a second side wall 13 arranged at an angle to each other. The driving member 2 is disposed within the installation cavity 11. The rotating part 3 is connected to the output end of the driving member 2 and is arranged eccentrically. The driving member 2 drives the rotating part 3 to rotate to strike the first side wall 12 or the second side wall 13, thereby forming an impact point 14 on the first side wall 12 or the second side wall 13. The impact point 14 is non-coincident with the center of mass of the exciter 100.

In this embodiment, the housing 1 of the exciter 100 is used to install, fix, and protect the driving member 2 and the rotating part 3 and other components, that is, the housing 1 provides an installation structure for the driving member 2 and the rotating part 3 and other components. It can be understood that the housing 1 can be a shell, an installation box, a box body, or other structures, and there is no limitation here. The housing 1 has an installation cavity 11 for placing and installing the driving member 2 and the rotating part 3 and other components. The installation cavity 11 can be a closed cavity, and of course, the installation cavity 11 can also be an open cavity.

It can be understood that the housing 1 can be an integral structure or a separable structure. To facilitate the disassembly and assembly of the driving member 2 and the rotating part 3 and other components, the housing 1 can be optionally set as a separable structure. That is, the housing 1 includes a first housing and a second housing. The first housing docks with the second housing and encloses to form the installation cavity 11. It should be noted that the housing 1 can be a regular shape or an irregular shape, such as a circular shape, an elliptical shape, a rectangular shape, a triangular shape, or other polygonal shapes, and can also be other irregular shapes, with no limitation here.

In this embodiment, in order to enable the exciter 100 to generate a force sensation in the rotational direction, the housing 1 has a first side wall 12 and a second side wall 13 arranged at an angle to each other. The first side wall 12 and the second side wall 13 can be the outer walls of the housing 1, or can be side walls or partition structures arranged in the installation cavity 11 of the housing 1, with no limitation here.

Optionally, the housing 1 is arranged in a rectangular shape. Further, the housing 1 can be optionally arranged as a square structure. In this embodiment, the driving member 2 is disposed within the installation cavity 11. The driving member 2 can be directly fixed to the inner wall of the housing 1, or can be installed within the installation cavity 11 through other structures, such as a bracket or an installation seat.

In this embodiment, the rotating part 3 is connected to the output end of the driving member 2 and is arranged eccentrically. It can be understood that the rotating part 3 can be an eccentric structure, or one end of the rotating part 3 can be connected to the output end of the driving member 2. When the driving member 2 drives the rotating part 3 to rotate, the rotating part 3 performs a circular motion around the output end of the driving member 2. That is, the position where the rotating part 3 is connected to the output end of the driving member 2 is located at an eccentric position of the rotating part 3 itself (the position where the rotating part 3 is connected to the output end of the driving member 2 does not coincide with the center of the rotating part 3).

It can be understood that by controlling the driving member 2 to drive the rotating part 3 to rotate, the rotating part 3 strikes the first side wall 12 or the second side wall 13, and forms an impact point 14 on the first side wall 12 or the second side wall 13. The impact point 14 is non-coincident with the center of mass of the exciter 100. Thus, when the rotating part 3 strikes the first side wall 12 or the second side wall 13, a torque can be generated in the rotational direction, enabling the exciter 100 to produce a force sensation in the rotational direction. Meanwhile, by providing the structure in which the driving member 2 drives the eccentrically arranged rotating part 3 to rotate, the structure of the exciter 100 is effectively simplified, and the exciter 100 is enabled to achieve high-speed continuous operation and produce a strong and clear force sensation.

It should be noted that the exciter 100 also includes a controller or control structure that can control the driving member 2 to drive the rotating part 3 to rotate. It can be understood that the controller or control structure can be a separate controller or remote controller, or it can be an integrated control circuit or control button structure on the exciter 100, with no limitation here.

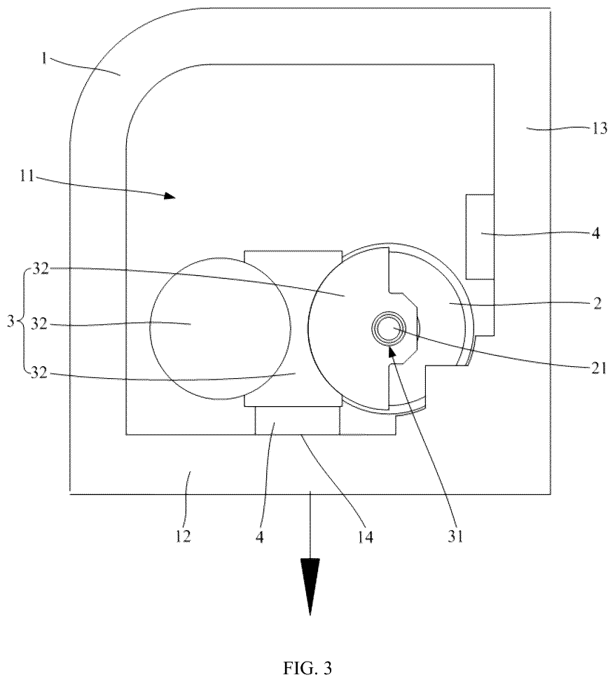

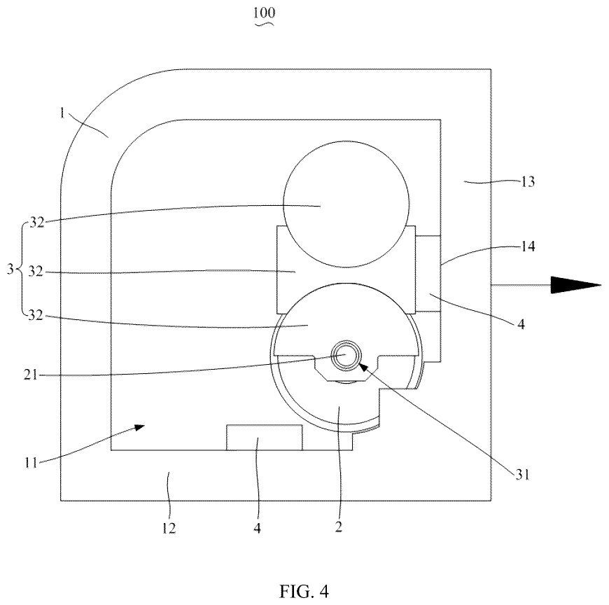

As shown in FIG. 3, in this embodiment, the driving member 2 is controlled to rotate in a forward direction to drive the rotating part 3 to rotate counterclockwise, so that the rotating part 3 strikes the first side wall 12, thereby generating a torque in the counterclockwise direction and enabling the exciter 100 to produce a force sensation in the counterclockwise rotational direction. As shown in FIG. 4, the driving member 2 is controlled to rotate in a reverse direction to drive the rotating part 3 to rotate clockwise, so that the rotating part 3 strikes the second side wall 13, thereby generating a torque in the clockwise direction and enabling the exciter 100 to produce a force sensation in the clockwise rotational direction.

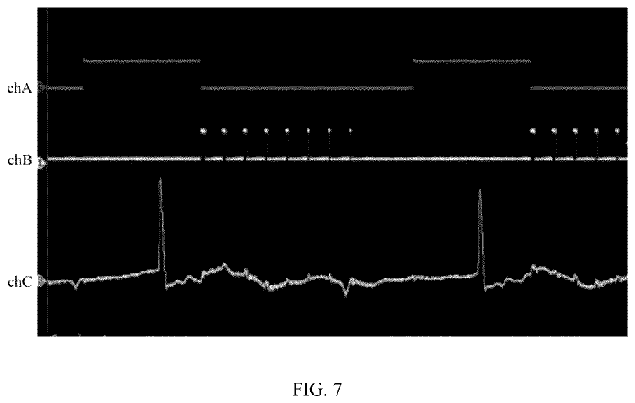

It can be understood that, as shown in FIG. 7, when the exciter 100 is installed in an electronic device 600 or a product and an accelerometer is used to detect the vibration of the exciter 100, the continuous unidirectional torque generated by the electronic device 600 can be detected. In FIG. 7, chA is the control signal for the forward rotation of the driving member 2, chB is the control signal for the reverse rotation of the driving member 2, and chC is the acceleration waveform of the acceleration on the electronic device 600. It can be seen from this that the housing 1 has a distinct unidirectional rotational vibration sensation.

The exciter 100 of the present disclosure forms an installation cavity 11 within the housing 1, thereby utilizing the installation cavity 11 to install, fix, and protect the driving member 2 and the rotating part 3. The housing 1 has a first side wall 12 and a second side wall 13 arranged at an angle to each other. The rotating part 3 is connected to the output end of the driving member 2 and is arranged eccentrically. When the driving member 2 drives the rotating part 3 to rotate, the rotating part 3 strikes the first side wall 12 or the second side wall 13, forming an impact point 14 on the first side wall 12 or the second side wall 13. The impact point 14 is non-coincident with the center of mass of the exciter 100. Thus, when the rotating part 3 strikes the first side wall 12 or the second side wall 13, a torque can be generated in the rotational direction, enabling the exciter 100 to produce a force sensation in the rotational direction. Meanwhile, by providing the structure in which the driving member 2 drives the eccentrically arranged rotating part 3 to rotate, the structure of the exciter 100 is effectively simplified, and the exciter 100 is enabled to achieve high-speed continuous operation and produce a strong and clear force sensation.

In this embodiment, as shown in FIGS. 1 to 4, the driving member 2 can be optionally selected as a rotor motor. The rotor motor has a rotation shaft 21, and the rotating part 3 has a shaft hole 31. The shaft hole 31 is arranged eccentrically on the rotating part 3, and the rotation shaft 21 is inserted into the shaft hole 31.

It can be understood that the structure of the rotating part 3 can be a regular shape or an irregular shape. Optionally, the shape of the rotating part 3 can be circular, elliptical, rectangular, triangular, or polygonal. The shaft hole 31 does not coincide with the shape center of the rotating part 3. Of course, the shape of the rotating part 3 can also be irregular, with no limitation here.

In one embodiment, the rotating part 3 includes at least one mass block 32. It can be understood that the material of the mass block 32 can be a metal, that is, the mass block 32 is made of metal. Of course, the mass block 32 can also be a non-metal, that is, the mass block 32 is made of non-metal.

It should be noted that, in order to enable the exciter 100 to produce a strong and clear force sensation, the mass block 32 of the rotating part 3 adopts a relatively heavy structure. Optionally, the mass block 32 is made of metal. To further increase the mass of the rotating part 3, the rotating part 3 can also be provided with counterweights or multiple mass blocks 32 on the mass block 32. The counterweights or multiple mass blocks 32 are located in the radial direction or circumferential direction of the rotation center of the rotating part 3, and the shaft hole 31 is located at the eccentric position of the overall rotating part 3 formed (that is, the shaft hole 31 does not coincide with the center of the overall rotating part 3 formed).

In one embodiment, the rotating part 3 includes three mass blocks 32. One mass block 32 is connected to the output end of the driving member 2 and is arranged eccentrically. The other two mass blocks 32 are sequentially connected and arranged along the radial direction of the rotating part 3. Alternatively, the other two mass blocks 32 are sequentially connected and arranged along the circumferential direction of the mass block 32.

In this embodiment, as shown in FIGS. 1 to 4, the number of mass blocks 32 in the rotating part 3 can be one, two, three, four, or multiple, with no limitation here. In the multiple mass blocks 32, the shaft hole 31 on the mass block 32 connected to the rotation shaft 21 of the driving member 2 is located at the eccentric position of that mass block 32. At this time, the other mass blocks 32 are connected in the radial direction or circumferential direction of that mass block 32, and the distance from the other mass blocks 32 to the shaft hole 31 is greater than the distance from the other mass blocks 32 to the center of that mass block 32.

Of course, the shaft hole 31 can also be located at the center of the mass block 32. In this case, the other mass blocks 32 are connected to one side of this mass block 32, making the overall rotating part 3 an eccentric structure. There is no limitation here.

In one embodiment, the angle of rotation of the rotating part 3 driven by the driving member 2 can be optionally selected as 90°. It is defined that when the driving member 2 drives the rotating part 3 to rotate in a forward direction, the rotating part 3 strikes the first side wall 12. It is defined that when the driving member 2 drives the rotating part 3 to rotate in a reverse direction, the rotating part 3 strikes the second side wall 13.

In this embodiment, as shown in FIGS. 1, 3, and 4, the first side wall 12 and the second side wall 13 of the housing 1 can optionally be arranged perpendicularly. The driving member 2 is disposed adjacent to the junction between the first side wall 12 and the second side wall 13. Optionally, the driving member 2 is located on the diagonal of the angle formed by the first side wall 12 and the second side wall 13.

Of course, in other embodiments, the second side wall 13 may not be perpendicular to the first side wall 12. For example, when the rotating part 3 is arranged in a sector shape, the first side wall 12 and the second side wall 13 may not be perpendicular when the driving member 2 drives the rotating part 3 to rotate 90° to collide with the first side wall 12 or the second side wall 13. There is no limitation here.

It can be understood that the rotating part 3 is located on the side away from the angle formed by the first side wall 12 and the second side wall 13, so that the driving member 2 drives the rotating part 3 to rotate 90°, thereby causing the rotating part 3 to strike the first side wall 12 or the second side wall 13.

Of course, the angle of rotation of the rotating part 3 driven by the driving member 2 can also be greater than 90° or less than 90°. It should be noted that when the line connecting the rotation shaft 21 of the driving member 2 and the center of the rotating part 3 is not parallel to the first side wall 12 or the second side wall 13, the angle of rotation of the rotating part 3 driven by the driving member 2 can be greater than 90° or less than 90°. That is, when the rotating part 3 strikes the first side wall 12, the line connecting the rotation shaft 21 of the driving member 2 and the center of the rotating part 3 is not parallel to the first side wall 12, and when the rotating part 3 strikes the second side wall 13, the line connecting the rotation shaft 21 of the driving member 2 and the center of the rotating part 3 is not parallel to the second side wall 13. In this case, the angle of rotation of the rotating part 3 driven by the driving member 2 can be greater than 90° or less than 90°. There is no limitation here.

In this embodiment, as shown in FIG. 3, it is defined that the driving member 2 drives the rotating part 3 to rotate in a forward direction, that is, when the driving member 2 rotates in a forward direction, it drives the rotating part 3 to rotate counterclockwise, causing the rotating part 3 to strike the first side wall 12. As shown in FIG. 4, it is defined that the driving member 2 drives the rotating part 3 to rotate in a reverse direction, that is, when the driving member 2 rotates in a reverse direction, it drives the rotating part 3 to rotate clockwise, causing the rotating part 3 to strike the second side wall 13.

In one embodiment, the distance from the impact point 14 on the first side wall 12 to the junction between the first side wall 12 and the second side wall 13 is equal to the distance from the impact point 14 on the second side wall 13 to the junction between the first side wall 12 and the second side wall 13.

In this embodiment, as shown in FIGS. 3 and 4, to ensure that the distance from the impact point 14 formed by the collision of the rotating part 3 with the first side wall 12 to the junction between the first side wall 12 and the second side wall 13 is equal to the distance from the impact point 14 formed by the collision of the rotating part 3 with the second side wall 13 to the junction between the first side wall 12 and the second side wall 13, so that the force sensation generated by the exciter 100 in the counterclockwise rotational direction is consistent with that in the clockwise rotational direction, thereby enhancing the user experience, the output end of the driving member 2 (which is also the rotation center of the rotating part 3) is located on the angle bisector of the angle formed by the first side wall 12 and the second side wall 13.

In one embodiment, the exciter 100 also includes a cushioning part 4. The cushioning part 4 is disposed on the first side wall 12 and/or the second side wall 13 and is located at the impact point 14. Alternatively, the cushioning part 4 is disposed on the rotating part 3, and when the driving member 2 drives the rotating part 3 to rotate, the cushioning part 4 abuts against the impact point 14.

In this embodiment, as shown in FIGS. 1 to 4, by providing the cushioning part 4, it can be used to adjust the impact force of the rotating part 3 and to regulate the susceptible frequency of the vibration wave, making the peak of the waveform in FIG. 7 sharper. At the same time, the cushioning part 4 also has a noise-reducing effect.

It can be understood that the cushioning part 4 can be disposed on the first side wall 12 and/or the second side wall 13 of the housing 1 and is located at the impact point 14. Of course, the cushioning part 4 can also be disposed on the rotating part 3, so that when the driving member 2 drives the rotating part 3 to rotate, the cushioning part 4 abuts against the impact point 14.

In this embodiment, there are multiple cushioning parts 4, which are respectively disposed on the first side wall 12 and the second side wall 13. Alternatively, multiple cushioning parts 4 are disposed on opposite sides of the rotating part 3, so that when the rotating part 3 strikes the first side wall 12, the first side wall 12 abuts against the cushioning part 4, or when the rotating part 3 strikes the second side wall 13, the second side wall 13 abuts against the cushioning part 4, etc., with no limitation here.

Optionally, the cushioning part 4 is made of a compressible material, such as foam, sponge, rubber pad, etc., with no limitation here. That is, the cushioning part 4 does not use a rigid material.

In this embodiment, the driving member 2 is fixedly installed in the installation cavity 11, and its relative position does not change. The multiple mass blocks 32 of the rotating part 3 are combined as a whole, and the overall movement of the multiple mass blocks 32 is synchronized as an eccentric mass block.

It can be understood that the rotating part 3 is driven to rotate by the driving member 2. When the rotating part 3 moves to the two extreme positions (that is, in contact with the first side wall 12 or the second side wall 13), it collides with the corresponding first side wall 12 or second side wall 13 of the housing 1. When the rotating part 3 collides with the first side wall 12 or the second side wall 13 of the housing 1, a rapid braking effect is generated, and the corresponding impact tactile sensation is received on the housing 1. When the impact position is away from the center of mass of the exciter 100 or the electronic device 600, the corresponding rotational tactile sensation can be generated. When the rotation direction of the output driving member 2 is forward, and vice versa is reverse, the driving force during reverse rotation is reduced by a method similar to chopping or PWM (Pulse Width Modulation), thereby reducing the impact force during reverse braking. Thus, a simple structure with a unidirectional rotational tactile sensation can be achieved.

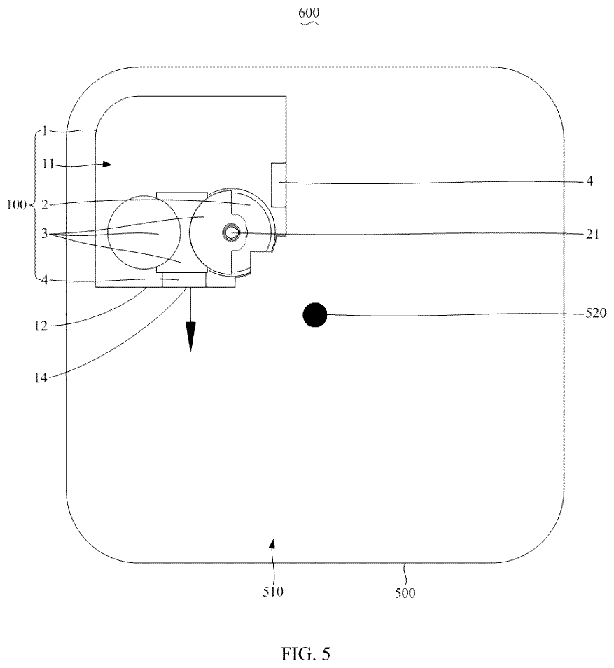

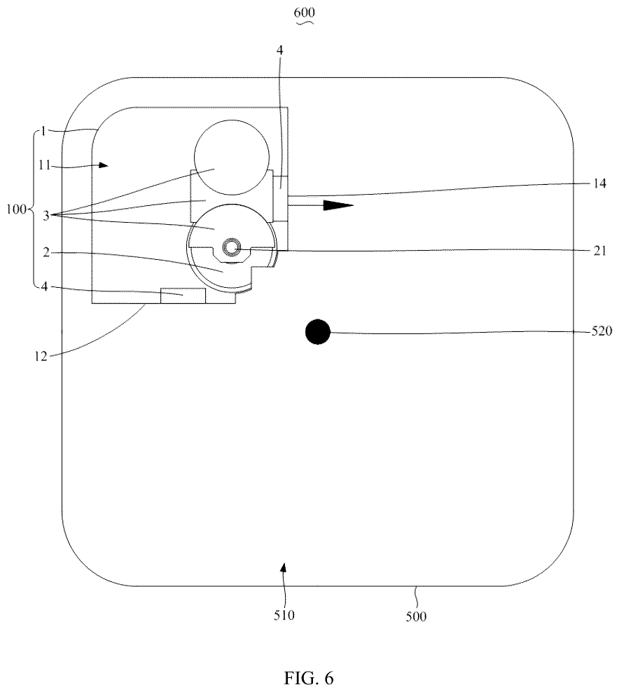

As shown in FIGS. 5 and 6, the present disclosure also proposes an electronic device 600, which includes a device body 500 and the aforementioned exciter 100. The device body 500 has an installation space 510, and the exciter 100 is disposed within the installation space 510. The specific structure of the exciter 100 refers to the foregoing embodiments. Since this electronic device adopts all the technical solutions of the foregoing embodiments, it therefore has at least all the beneficial effects brought by the technical solutions of the foregoing embodiments, which will not be repeated one by one here.

In this embodiment, as shown in FIGS. 5 and 6, the impact point 14 of the exciter 100 is non-coincident with the center of mass 520 of the electronic device.

It can be understood that the rotating part 3 of the exciter 100 is driven to rotate by the driving member 2. When the rotating part 3 moves to the two extreme positions (that is, in contact with the first side wall 12 or the second side wall 13 of the housing 1 of the exciter 100), it collides with the corresponding first side wall 12 or second side wall 13 of the housing 1. When the rotating part 3 collides with the first side wall 12 or the second side wall 13 of the housing 1 of the exciter 100, a rapid braking effect is generated, and the corresponding impact tactile sensation is received on the housing 1. When the impact position is away from the center of mass of the electronic device 600, the corresponding rotational tactile sensation can be generated. When the rotation direction of the output driving member 2 is forward, and vice versa is reverse, the driving force during reverse rotation is reduced by a method similar to chopping or PWM (Pulse Width Modulation), thereby reducing the impact force during reverse braking. Thus, a simple structure with a unidirectional rotational tactile sensation can be achieved.

The above description is only an optional embodiment of the present disclosure and does not limit the scope of the patent of the present disclosure. Any equivalent structural transformation made based on the description and drawings of the present disclosure, or any direct or indirect applications thereof in other related technical fields, shall fall within the scope of patent protection of the present disclosure.

1. An exciter, comprising:
a housing having an installation cavity, a first side wall and a second side wall arranged at an angle to each other;
a driving member disposed within the installation cavity; and
a rotating part connected to an output end of the driving member and being arranged eccentrically;
wherein the driving member is configured to drive the rotating part to rotate and strike the first side wall or the second side wall, thereby forming an impact point on the first side wall or the second side wall, the impact point being non-coincident with a center of mass of the exciter.

2. The exciter according to claim 1, wherein a rotation angle of the rotating part driven by the driving member is 90°;
when the driving member drives the rotating part to rotate is along a forward direction, the rotating part strikes the first side wall; and
when the driving member drives the rotating part to rotate along a reverse direction, the rotating part strikes the second side wall.

3. The exciter according to claim 1, wherein the first side wall is arranged perpendicularly to the second side wall.

4. The exciter according to claim 3, wherein the driving member is disposed adjacent to a junction between the first side wall and the second side wall;
and/or, a distance from the impact point on the first side wall to the junction between the first side wall and the second side wall is equal to a distance from the impact point on the second side wall to the junction between the first side wall and the second side wall.

5. The exciter according to claim 1, further comprises a cushioning part;
wherein, the cushioning part is disposed on the first side wall and/or the second side wall, and is located at the impact point; or, the cushioning part is disposed on the rotating part, and when the driving member drives the rotating part to rotate, the cushioning part abuts against the impact point.

6. The exciter according to claim 1, wherein the driving member comprises a rotor motor, the rotor motor being provided with a rotation shaft, the rotating part being provided with a shaft hole, the shaft hole being eccentrically arranged on the rotating part, the rotation shaft being inserted into the shaft hole.

7. The exciter according to claim 1, wherein the rotating part comprises at least one mass block;
the mass block is made of metal or non-metal.

8. The exciter according to claim 7, wherein the rotating part comprises a first mass block, a second mass block, and a third mass block, the first mass block being connected to the output end of the driving member and being arranged eccentrically;
the second and the third mass blocks are sequentially connected and arranged along a radial direction of the rotating part; or, the second and the third mass blocks are sequentially connected and arranged along a circumferential direction of the first mass block.

9. An electronic device, comprising:
a device body having an installation space therein; and
the exciter according to claim 1, the exciter being disposed within the installation space and coupled to the device body.

10. The electronic device according to claim 9, wherein the impact point of the exciter is non-coincident with the center of mass of the electronic device.
